(19) United States
(12) Patent Application Publication
(10) Pub. No.: US 2015/0090469 A1
(43) Pub. Date: Apr. 2, 2015

(54) Vibratory Hammer with Passive Lubrication System for Bearings

(71) Applicant: Hydraulic Power Systems, Inc., North Kansas City, MO (US)

(72) Inventors: Robert James Zimmerman, Shawnee Mission, KS (US); Kurt N. Winters, North Palm Beach, FL (US)

(73) Assignee: HYDRAULIC POWER SYSTEMS, INC., North Kansas City, MO (US)

(21) Appl. No.: 14/564,908

(22) Filed: Dec. 9, 2014

(51) Int. Cl. B25D 17/26; E02D 7/18

(52) U.S. Cl. CPC B25D 17/26; E02D 7/18
USPC 173/49

(57) ABSTRACT

Small wells cut into the upper interior surface of the head plate collect oil that is sprayed forcefully upward by the rotating gears and eccentric weights and channels that oil through a throughbore across the width of the head plate, routing the oil into a hose or bored channel at each end of the throughbore, with oil in the hoses or bored channels flowing through bearing access ports into the bearings on the rotating eccentric weights. A separate oil collection well, throughbore and hose arrangement is provided for each of the eccentric weight and gear sets and may be provided for pinion gears connected to hydraulic drive motors.

### CROSS-REFERENCE TO RELATED APPLICATIONS

Not Applicable.

### STATEMENT REGARDING FEDERALLY SPONSORED RESEARCH OR DEVELOPMENT

Not applicable.

### SEQUENCE LISTING

Not applicable

### BACKGROUND OF THE INVENTION

The present invention is related to providing a passive lubrication system for lubricating the bearings and shafts of a vibratory hammer that are adjacent to the side walls of the gear case of the vibratory hammer.

### DESCRIPTION OF THE RELATED ART INCLUDING INFORMATION DISCLOSED UNDER 37 C.F.R. 1.97 AND 1.98.

Vibratory hammers include a housing or case that is sealed with vibrating weights inside the case. The vibrating weights operate in a number of ways. At least two counter-rotating shafts having an eccentric mass on them. In some cases, a reciprocating piston may be inside of a cylinder in the eccentric portion of the weight, increasing the out-of-balance vibratory effect of the eccentric weights as disclosed, for example, in U.S. Pat. No. 5,988,297, which is hereby incorporated into this paper by reference. Alternatively, the rotating masses may themselves have fixed eccentric weights, as is the case with the vibratory hammer discussed in detail in connection with the present invention, as disclosed in U.S. Pat. No. 4,819,740, which is hereby incorporated into this paper by reference. A hydraulic motor or other type of motor rotates the gears inside the gear case, rotating the eccentric weights and causing the vibratory hammer to vibrate.

A crane is typically used to hold a vibratory hammer above a pile or the like that is to be driven into the ground.

A sealed gear case holds the gears and eccentric weights or other vibrating components (collectively, eccentric weights). The gear case contains about forty liters of gear oil, typically SAE 90 gear oil, with oil covering the lower portions of the gears and eccentric weight sets, which is splashed everywhere by the rotating eccentrics and the rotating gear sets. Most vibratory hammers have no other lubrication system. Experience has shown, however, that the ends of the shafts that carry the eccentric weights, which are typically mounted on axles that are set in journals in end caps fitted with roller bearings, are less well lubricated than other parts in the gear case. The end bearings on the shafts that carry the eccentric weights typically have a shorter life expectancy due to the lack of sufficient lubrication.

Efforts to overcome this problem include providing an external oil pump with suitable plumbing to deliver oil to the roller bearing end caps. This proposed solution is quite expensive and does not work when the vibratory hammer moves out of level position during use, leaving the pump dry, as frequently happens. The pumps themselves present reliability issues.

Therefore, there is a need for a vibratory hammer with passive lubrication system for bearings in a vibratory hammer of any design that operates whenever the vibratory hammer is operating, regardless of the orientation of the vibratory hammer, as long as it is upright, and that is inexpensive, reliable and durable.

### BRIEF SUMMARY OF THE INVENTION

Accordingly, it is a primary object of the present invention to provide a vibratory hammer with passive lubrication system for bearings in a vibratory hammer of any design that operates whenever the vibratory hammer is operating, regardless of the orientation of the vibratory hammer, as long as it is upright.

It is another object of the present invention to provide a vibratory hammer with passive lubrication system for bearings in a vibratory hammer of any design that is inexpensive.

It is another object of the present invention to provide a vibratory hammer with passive lubrication system for bearings in a vibratory hammer of any design that is reliable.

It is another object of the present invention to provide a vibratory hammer with passive lubrication system for bearings in a vibratory hammer of any design that is durable.

These and other objects of the present invention are achieved by providing an oil gathering well formed into the, lower, surface of the gear case head inside the gear case, i.e., the top plate. The oil gathering well may be of any desirable shape, such as roughly V-shaped, dome shaped, and so forth, so long as it collects and concentrates the collected oil in a funnel-like fashion so that the oil can be directed through channels that lead to the end bearings of the gear and eccentric weight sets. The oil gathering well collects oil that is forcefully directed upwardly toward the oil collecting well by the rotating teeth the gears as the gear teeth travel through the oil that is pooled in the bottom of the gear and delivers it through a vertical channel that mates with a throughbore channel into hoses that drain the oil directly into the end cap bearings on both the front and rear side of the gear case. A substantial amount of oil and a significant pressure on the oil is achieved with this passive lubrication system. A separate system of an oil-gathering well, vertical channel and connected throughbore is provided for each axle that carries an eccentric weight. In an alternative embodiment, a pair of oil-gathering wells are joined and feed oil to the bearings of two rotating eccentric weights.

Other objects and advantages of the present invention will become apparent from the following description taken in connection with the accompanying drawings, wherein is set forth by way of illustration and example, the preferred embodiment of the present invention and the best mode currently known to the inventor for carrying out his invention.

### BRIEF DESCRIPTION OF THE SEVERAL VIEWS OF THE DRAWING

FIG. 1 is front view of a vibratory hammer with a passive lubrication system for bearings in a vibratory hammer of any design (vibratory hammer) according to the present invention.

FIG. 2 is a left side view of the vibratory hammer of FIG. 1.

FIG. 3 is a fragmentary side view of the vibratory hammer of FIG. 1 taken along lines 3-3 of FIG. 1 showing external hoses for delivering oil to bearings.

FIG. 4 is a fragmentary side view of he vibratory hammer of FIG. 1 taken along lines 3-3 of FIG. 1 showing an alternative embodiment of internal passageways for delivering oil to bearings.

FIG. 5 is a fragmentary front view of a portion of the vibratory hammer of FIG. 1 with a portion of the front or rear side wall cut away to show the internal gear arrangement.

FIG. 6 is an isometric view of an eccentric weight and gear set of the vibratory hammer of FIG. 1.

FIG. 7 is an isometric view of the gear case head plate of the vibratory hammer of FIG. 1 with the top cover removed showing the weight fastened to the gear case head plate of the vibratory hammer of FIG. 1.

FIG. 8 is a bottom isometric view of the portion of the gear case head plate of the vibratory hammer of FIG. 1 showing the oil-gathering wells.

FIG. 9 is a cross section taken along lines 9-9 of FIG. 7 showing an oil-gathering well connected to a vertical channel, which is connected to a throughbore in the vibratory hammer of FIG. 1.

FIG. 10 is a cross section taken along lines 10-10 of FIG. 9 showing the oil-gathering well connected to a vertical channel, which is connected to a throughbore in the vibratory hammer of FIG. 1.

FIG. 11 is an enlarged fragmentary isometric view of a portion of the lower surface of the gear case head plate of the vibratory hammer of FIG. 1 showing an oil-gathering well connected to a vertical channel, which is connected to a throughbore in the head plate of vibratory hammer of FIG. 1.

FIG. 12 is a bottom isometric view of the head plate of the vibratory hammer of FIG. 1, showing an alternative embodiment of the passive lubrication system in which two oil-gathering wells are immediately adjacent to one another.

FIG. 13 is an enlarged fragmentary bottom isometric view isometric view of the alternative embodiment of FIG. 12.

### DETAILED DESCRIPTION OF THE INVENTION

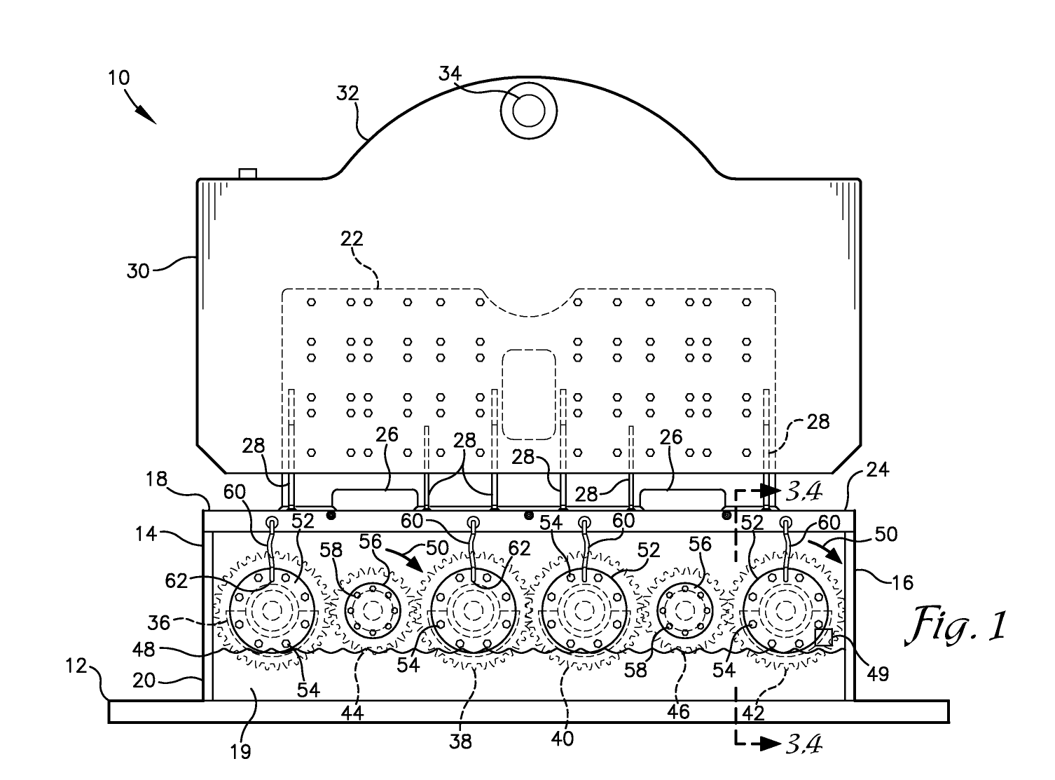

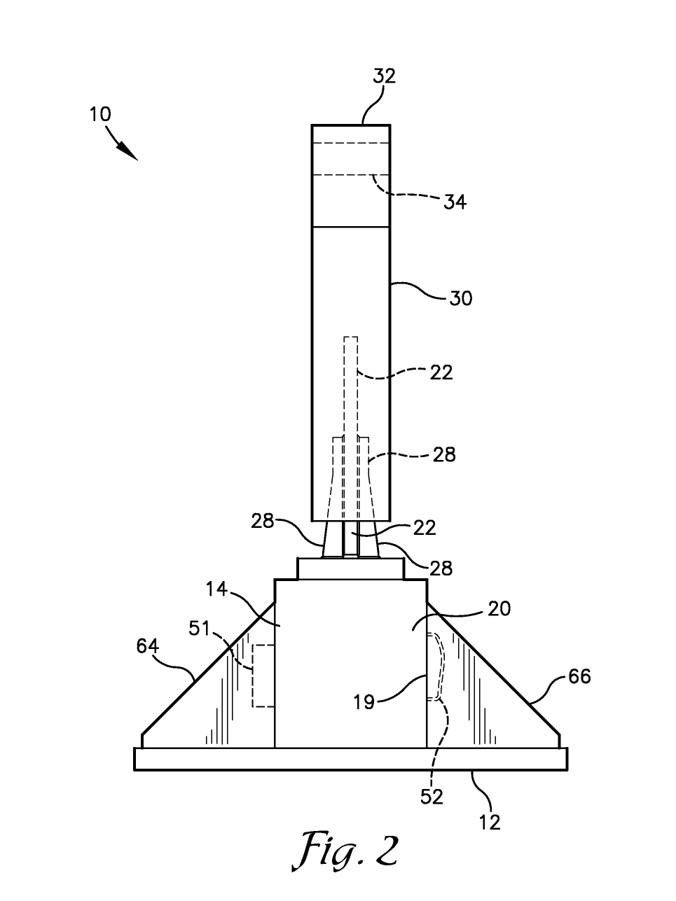

Referring to FIG. 1, a vibratory hammer with passive lubrication system for bearings (vibratory hammer) 10 includes a base plate 12, a left end plate 14, a right end plate 16 and a head plate 18, and a front plate 19 and a rear plate 68 (FIG. 2), which are joined together to form a gear case 20, that is sealed to be leakproof. A large vertical plate weight 22 is connected to the top surface 24 of the head plate 18 by welding or the like. Six spaced vertical reinforcement ribs 28 are connected to the top surface 24 of the head plate 18 and to the top lifting plate 24 by welding or the like. A suspension 30 is connected to the top lifting plate 24 by rubber isolators to substantially isolate vibration from the gear cast 20 from the suspension 30 and covers it, down to a 20-40 centimeters or so of the top surface of the head plate 18, so as to allow access to the head bolts (not shown) and movement of the vibratory hammer during operation. An arced portion 32 in the middle of the length of the top edge of the suspension 30 includes a suspension lifting pin 34, providing a lift point for a crane (not shown), used for suspending the vibratory hammer 10 during operation.

Still referring to FIG. 1, inside the gear case 20 are four identical rotating eccentric weight and gear sets, which are numbered, from left to right, 36, 38, 40, 42. A left pinion gear 44 is placed between the eccentric weights 36, 38 and a right pinion gear 46 is placed between the eccentric weights 40, 42. The eccentric weight and gear sets 36, 38, 40, 42 mesh. Each of the eccentric weight and gear sets 36, 38, 40, 42 and the left and right pinion gears 44, 46 form a continuous gear train driven by a single power source, such as the hydraulic motors 51, one of which is operatively connected to each of the pinion gears 44, 46. Each of the gear sets 36, 38, 40, 42, 44, 46 is mounted on a splined axle received in a central splined bore of the gear. Each end of each axle is supported at the front and rear plates 19, 68 of the gear case 20. One or more eccentric weight and gear sets or the like may be used. The passive oiling system described here does not depend on any particular means of providing vibration so long as at least one rotating member is used. The passive oiling system may be used in other applications with machines having a splashing oil lubrication system without an oil pump.

Still referring to FIG. 1, each eccentric weight and gear set 36, 38, 40, 42 is set in a journal capped by a cover plate 52, which is fastened to the gear case 20 by the bolts 54. The pinion gears 44, 46 are covered by separate, smaller, pinion gear cover plates 56 on one side of the gear case 20, which are secured to the gear case 20 by the bolts 58. A hydraulic motor 51 is mounted to each pinion gear 44, 46 on the side of the gear case that is opposite to the pinion gear cover plates 56. An oil delivery hose 60 runs from the head plate 18 to each of the cover plates 52, which are penetrated by distal end hose fitting 62, and delivers oil to the roller bearings of each eccentric weight and gear sets 36, 38, 40, 42. The oil level 48 in the gear case 20, visible through the site glass 49 when the vibratory hammer 10 is at rest, rises above the lower teeth of all the gears 36, 38, 40, 42, 44, 46. The oil delivered to the eccentric weight and gear sets 36, 38, 40, 42 comes from oil that sprays forcefully onto the inside surface of the head plate 18 during operation and a portion of that sprayed oil is directed into the oil collection wells, where it is collected and channeled to and the oil delivery hoses 60 as described below.

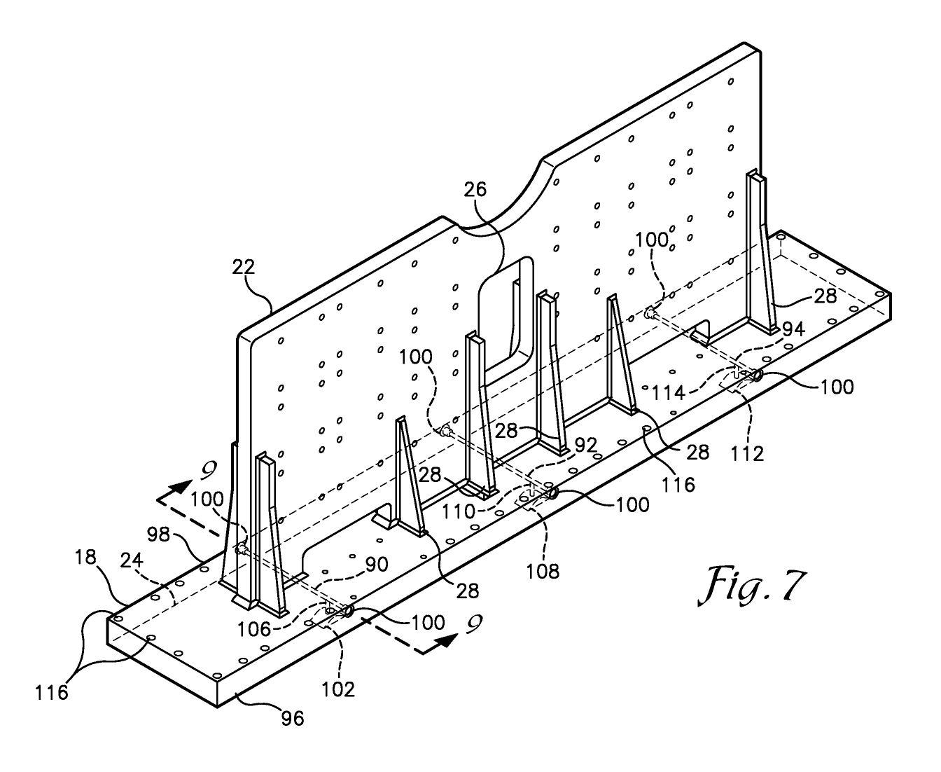

Still referring to FIG. 1, a separate hydraulic motor 51 is connected to the left pinion gear 44 and to the right pinion gear 46. Hydraulic motors 51 (best seen in FIG. 2) suitable for use in any vibratory hammer are available for clockwise or counterclockwise rotation (here defined as the vibratory hammer 10 is viewed in FIG. 1), but the direction of rotation is fixed in any particular hydraulic motor 51. In FIG. 1, the rightmost gear and eccentric set 42 rotates clockwise, as indicated by the directional arrow 50. The hydraulic motor 51 driving the pinion gear 46 rotates counterclockwise and the hydraulic motor 51 driving the left pinion gear 44 rotates clockwise. The direction of rotation of each gear in the gear train 36, 38, 40, 42, 44, 46 can be reversed by installing hydraulic motors of opposite rotation, if desired, i.e., operation of the vibratory hammer 10 does not depend on the direction of rotation of the gears, which would necessitate relocating the oil collecting wells 102, 108, 112 and associated bores (FIG. 7-13), which can be configured for more or fewer rotating pairs of pinions, gear and eccentric weight sets and so forth.

Still referring to FIG. 1, the front and rear of the vibratory hammer 10 are essentially the same, that is, symmetrical, so FIG. 1 can serve as both a front and a back or rear view with the only differences being that left and right would be reversed in a back or rear view and that the hydraulic motors 51 and the pinion gear cover plates 56 each appear only on either the front or the back of the hydraulic hammer 51.

Referring to FIG. 2, the base plate 12 is wider than the width of the gear case 20 and is connected to the gear case 20. The left triangular gusset 64 and a right triangular gusset 66 are connected to the base plate 12 and the front plate 19 and the rear plate 68 by welding. The right end view is the same as the left end view, except that the right and left sides of the view are reversed.

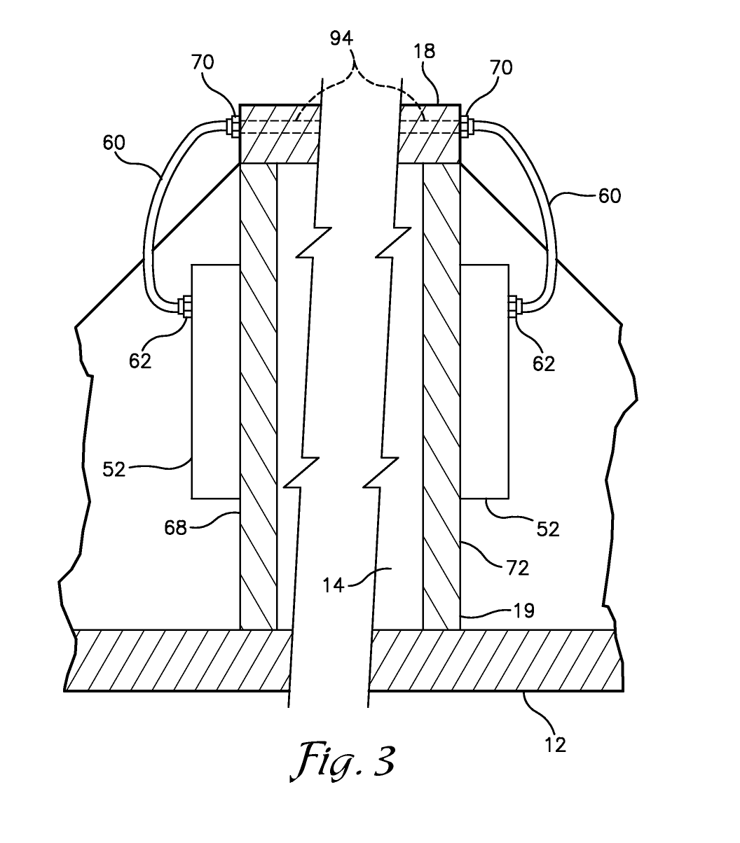

Referring to FIG. 3, the top of the oil delivery hose 60 is secured into the head plate 18 by the top fitting 70. The cover plate or plates 52 protrude outwardly from the front surface 72 of the front plate 19. The oil delivery hose 60 terminates in the front surface of the front plate 19 rather than in the top of the front plate 19 so that the oil is delivered closer to the axle and bearings of the eccentric weight and gear sets 36, 38, 40, 42 instead of on top of them. Each oil delivery hose 60 includes a distal end or hose fitting 62 terminating directly over a bearing set.

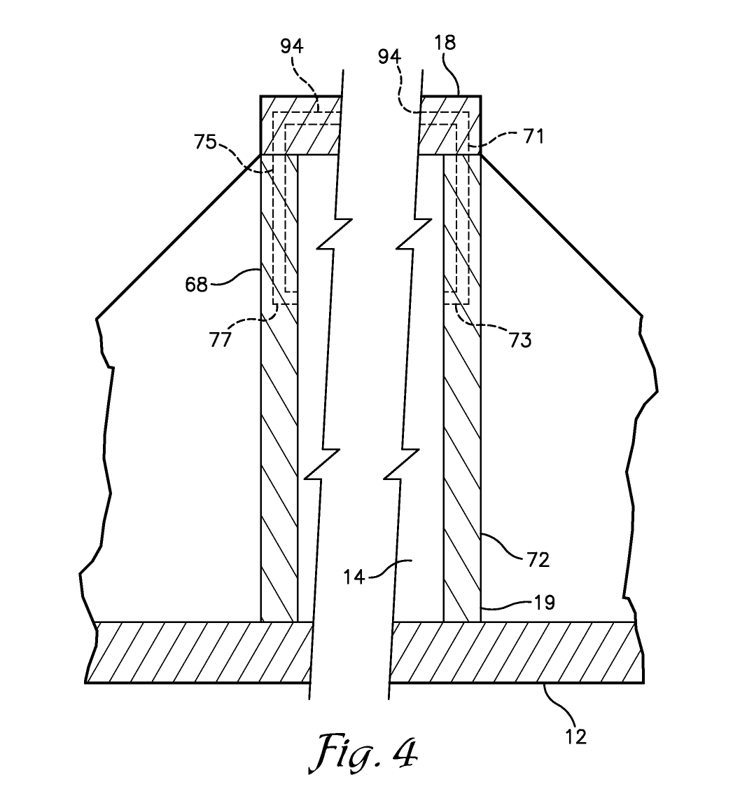

Referring to FIG. 4, the oil deliver hoses and associated hardware have been replaced by the vertical bore 71 and connected horizontal bore 73 in the front plate 19 and in the rear plate 68 by the vertical bore 75 and the connected horizontal bore 77. Both vertical channels or bores 71, 75 are connected to the right oil delivery bore 94. This alternative embodiment eliminates the possibility that the oil delivery hoses 60 will be damaged.

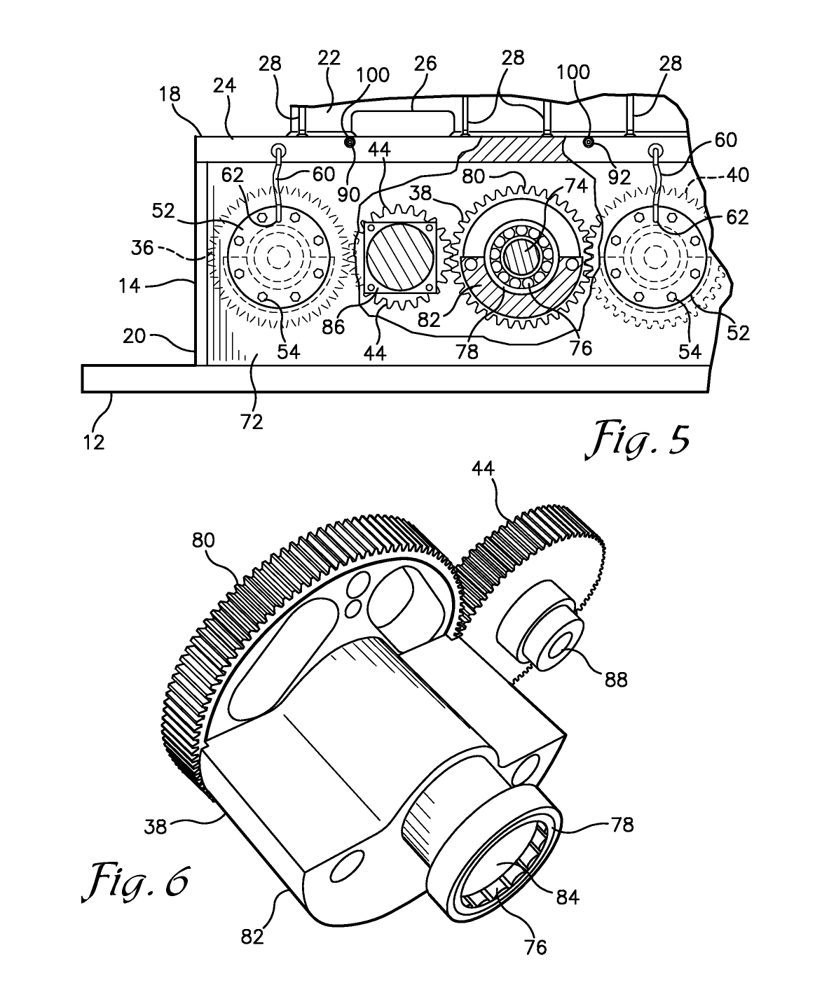

Referring to FIGS. 5, 6 each eccentric weight and gear set 36, 38, 40, 42 rotates about an axle 74 and includes a set of roller bearings 76 seated in a bearing race 78 and in contact with the axle 74, a gear face portion 80 and an eccentric weight portion 82. The gear face portion 80 and eccentric weight portion 82 include a bore 84 in the center of the gear face portion 80 for receiving the axle 74. The pinion gear 44 or 46 is mounted on a mounting plate 86 (FIG. 5) and a central splined bore 88 for receiving an axle.

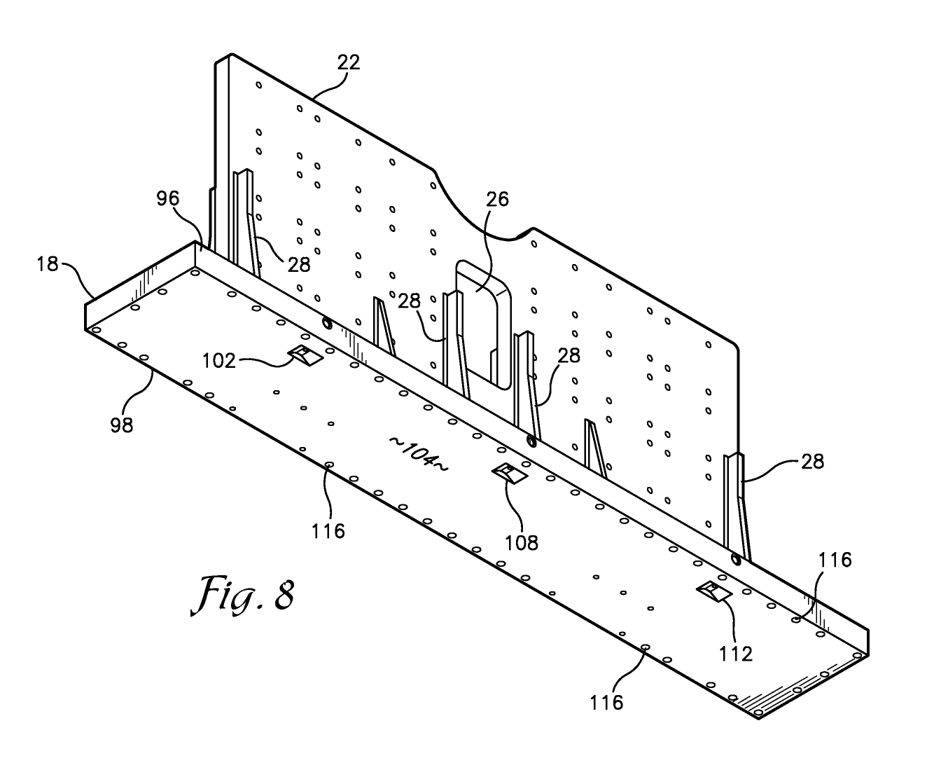

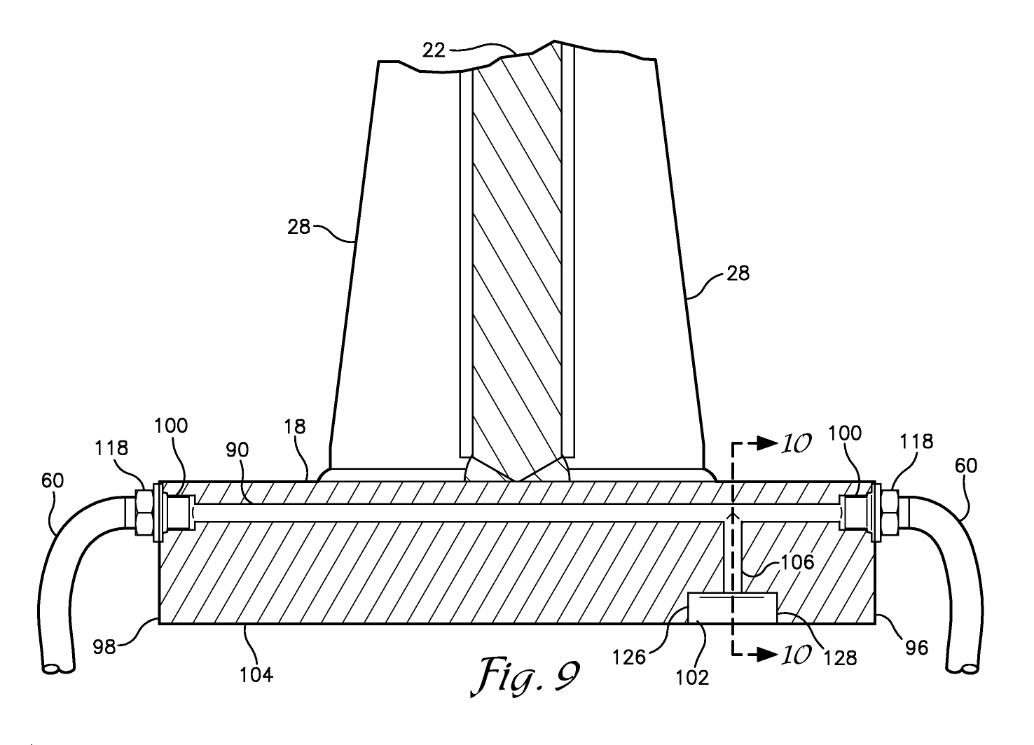

Referring to FIG. 7, a left oil delivery bore 90, a middle oil delivery bore 92 and a right oil delivery bore 94 are formed in the head 18 plate and run parallel on either end of the head plate 18 and from the front edge 96 of the head plate 18 to the rear edge 98 (FIGS. 7, 8) of the head plate 18. Each end of each oil delivery bore 90, 92 94 is flared to receive a fitting, which may be threaded, swaged, or the like, into the flared end 100. Adjacent to the front edge 96 of the head plate 18, a left oil collection well 102 is formed into the inside surface 104 (best seen in FIG. 8) of the head plate 18. The left oil collection well 102 is recessed into the inside surface 104 adjacent to the front edge 96 of the head plate 18 and is connected to the left oil delivery bore 90 by the short vertical connecting bore 106 that is formed in the center of the oil collection well 102 and is in all the oil collection wells, thereby providing the deepest reservoir of oil and the greatest pressure relative to any other oil collection point. In the same fashion, a middle oil collection well 108 is adjacent to the front edge 96 of the head plate 18 and is connected to the middle delivery bore 92 and connected to it by the short vertical connecting bore 110, and a right oil collection well 112 is adjacent to the front edge 96 of the head plate 18 and is connected to the right oil delivery bore 94 by the short vertical connecting bore 114.

As oil is sprayed forcefully upward inside the gear case 20 by the rotating gear and eccentric weight and gear sets 36, 38, 40, 42 and the pinion gears 44, 46, it is sprayed forcefully into and collects in each of the oil collection wells 102, 108, 112. Unexpected force upon the oil is generated by the gears dipping into the oil and spraying it upward, directing a portion into each oil collection well 102, 108, 13 with sufficient oil pressure being generated to force the oil to flow through the oil delivery bores 90, 92, 94, out through the flared ends 100, into the oil delivery hoses 60 and onto the roller bearings 76 at each end of the axles 74 under pressure. The oil collection wells 102, 108, 112 are located directly above the gear teeth and positioned in line with a vertical line tangent to the gears that have an upward rotation. By providing oil directly to the bearings at each both ends of the splined shafts carrying the eccentric weight and gear sets 36, 38, 40, 42, a more uniform supply of oil is provided to each bearing. The flow of oil is independent of the amplitude of the vibrations in the vibratory hammer 10. Further, the flow of oil remains substantially unchanged so long as the oil level is high enough that the gears pick it up, i.e., the vibratory hammer 10 does not need to be horizontal. adjacent to the front edge 96 of the head plate 18, rather than adjacent to the rear edge 98 of the head plate 18 or the middle of it because this arrangement causes a greater portion of the collected oil to be directed to the front of the gear case 20, that is, between the gear face portion 80 and the inside surface of the front plate 19. The bearings located there are the most starved for lubrication from natural splashing because any path from the interior of the gear case 20 to those bearings 74 is partially blocked by the large gear face portions 80. It is also possible if desired to construct the oil delivery bores 90, 92, 94 to direct oil to the front side or rear side of the vibratory hammer 10 or to move the location of the oil collection wells 102, 108 112 closer to the front or rear of the vibrator hammer 10 in order to change the amount of oil delivered to the bearing at the front or rear of the vibratory hammer 10 as desired. All of the oil collection wells 102, 108, 112, 130, described here have the same shape, although they may be dome shaped or have another shape that collects and concentrates quantities of oil and pressurizes them from the flow produced by the upward spraying of oil. Similarly, each of the oil delivery bores 90, 92, 94, 130, 132 and associated bores have the same construction, so comments directed to any oil collection well or any oil delivery bore pertain generally to any other oil collection well or oil delivery bore except ast to location.

Referring to FIG. 8, it is clear that the oil collection wells 102, 108, 112 are recessed into the inside, or underside, surface 104 of the head plate 18. The bolt holes 116 are for accepting bolts (not shown) for mounting the head plate 18 to the front and rear plates 19, 68.

Referring to FIG. 9, each end of the oil delivery bore 90 is fitted with a fitting 118 connecting an oil delivery hose 60 to a flared end 100 of the oil delivery bore 90. Each oil bore 90, 92, 94 includes a fitting 118 and an oil delivery hose 60 at each end.

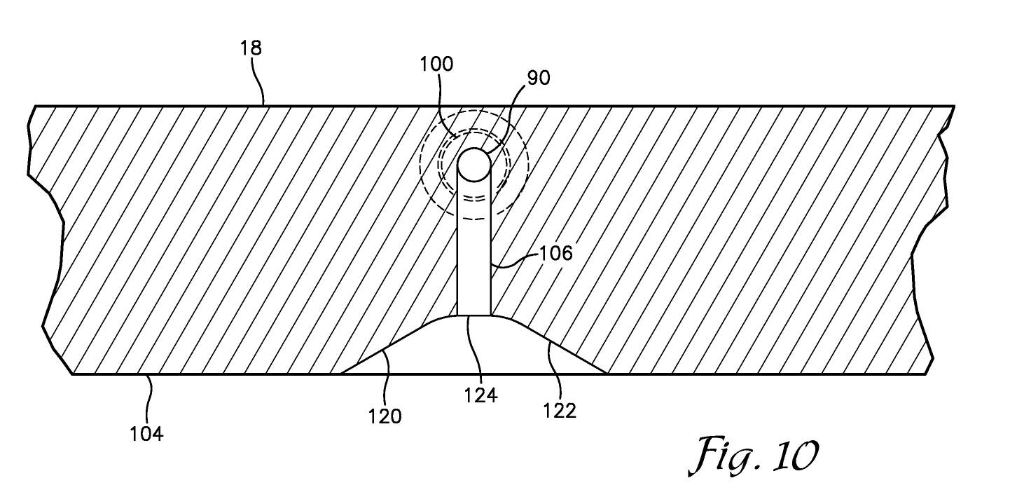

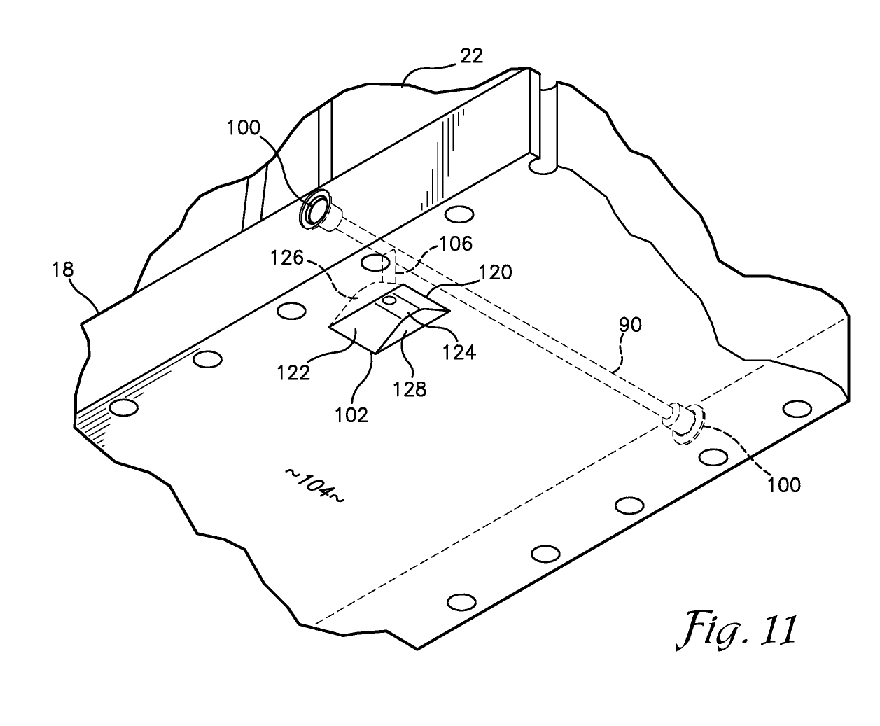

Referring to FIGS. 10, 11 the cross section of the oil collection well 94 includes a upward sloping left side wall portion 120 and an upward sloping right side wall portion 122 which are essentially straight and are joined together by a slightly arcuate top wall portion 124 that are inwardly sloping toward the lowest point of the oil collection wells 90, 92, 94, i.e., the collection point, which is the highest physical point of the oil collection wells 90, 92, 94 when the vibratory hammer 10 is upright as shown in FIG. 1 and have a roughly trapezoidal cross section acting as a funnel to concentrate the location of the collected oil and to develop the pressure necessary to drive the oil into the oil delivery bores 90, 92, 94 and into the oil delivery tubes or hoses 60. The oil collection wells 90, 92, 94 each also include a front side wall 126 and rear side wall 128 that are both perpendicular to the interior surface 104 of the head plate 18, although the front and rear side walls 126, 128 can also be formed to be inward sloping if desired, further increasing the concentration of oil pressure.

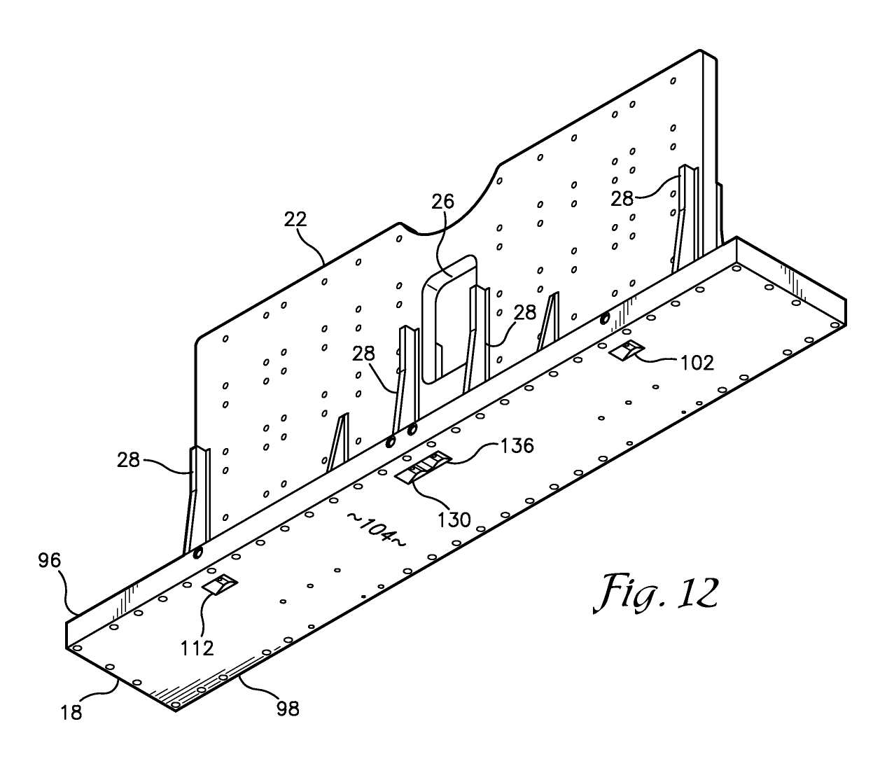

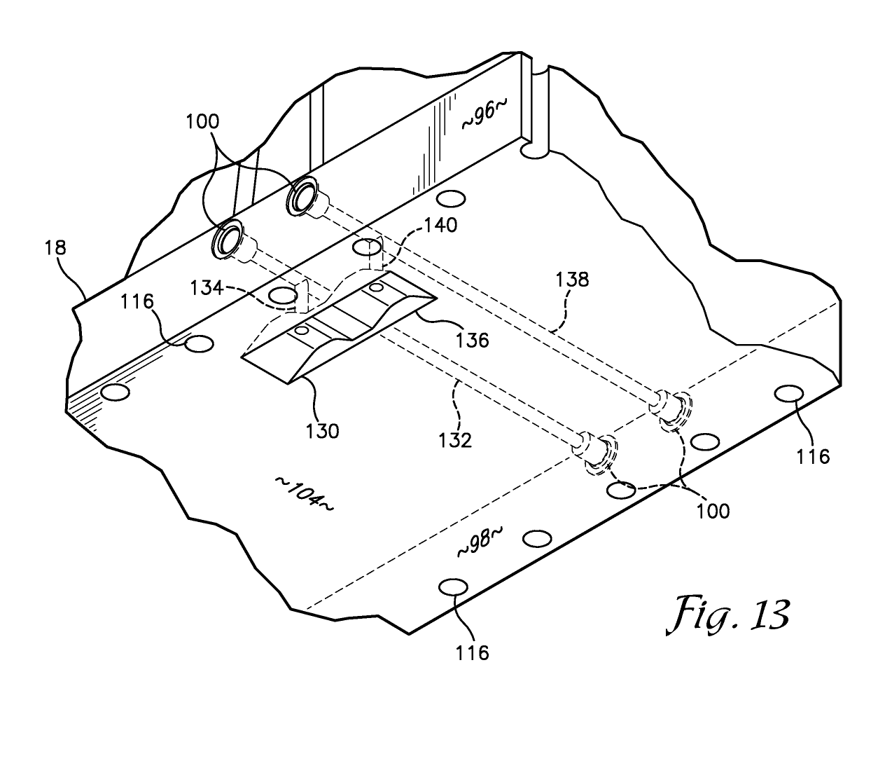

Referring to FIGS. 12, 13, an alternative embodiment is shown in which the middle oil collection well 108 of FIG. 6 has been replaced by two adjacent oil collection wells, a left middle oil collection well 130 connected to the left middle oil delivery bore 132 by the short vertical connection bore 134 and an adjacent right-middle oil collection well 136 connected to the right middle oil delivery bore 138 by the short vertical connection bore 140. This arrangement provides greater lubrication for the gears of the two middle eccentric weight and gear sets 38, 40 is suitable for small vibratory hammers where the gears are close together or where it is also desired to provide supplemental lubrication to the pinion gears 44, 46. In this case, the direction of travel of the oil delivery bores 90, 92, 94, 132,138 or otherwise may be changed so as to direct the flowing oil from any particular oil collection well, e.g., 130, 136 or otherwise to any bearing that supplemental lubrication is to be delivered to.

While the present invention has been described in accordance with the preferred embodiments thereof, the description is for illustration only and should not be construed as limiting the scope of the invention. Various changes and modifications may be made by those skilled in the art without departing from the spirit and scope of the invention as defined by the following claims. For example, the exact placement of the oil collection wells along the width of the head plate could be changed, as can the exact shape of the oil collection wells themselves. The number of eccentric weight and gear sets can obviously be varied. The power source can be different and so forth.

I claim:

1. A vibratory hammer comprising;
a. an enclosed gear case;
b. at least one rotating eccentric weight mounted inside said gear case;
c. a head plate on the top of the gear case; and
d. at least one oil collecting well formed in an interior surface of said head plate; and
e. means for conveying oil collected in said at least on oil collecting well to a bearing at at least one an end of an axle carrying said at least one rotating eccentric weight.

2. A vibratory hammer in accordance with claim 1 further comprising means for rotating said at least one eccentric weight operatively connected to said eccentric weight.

3. A vibratory hammer in accordance with claim 2 further comprising a throughbore through said head plate perpendicular to the length of said head plate in fluid communication with said at least one oil collecting well and means for conveying the collected oil from said bore to bearings inside said enclosed gear case to a bearing at a front of said gear case and to a bearing at a rear of said gear case.

4. A vibratory hammer in accordance with claim 3 wherein said oil collecting well further comprises a recess formed into said interior surface of said head plate.

5. A vibratory hammer in accordance with claim 4 wherein said oil collecting well further comprises a recess having inwardly sloped side walls acting as a funnel to concentrate the location of the collected oil.

6. A vibratory hammer in accordance with claim 5 further comprising at least three eccentric weights, each having an attached driving gear, and at least one oil collecting well above each said eccentric weight and gear sets.

7. A vibratory hammer in accordance with claim 6 further comprising a throughbore through said head plate adjacent to each said oil collecting well with each said throughbore having an end terminating above each end of an axle carrying one said eccentric weight and gear set.

8. A vibratory hammer in accordance with claim 7 wherein each said oil collecting well is adjacent to a front edge of said head plate.

9. A vibratory hammer in accordance with claim 8 wherein each said end of each said throughbore is connected to an oil delivery hose and a distal end of each said oil delivery hose is in fluid communication with the interior of said gear case at a location whereby oil is directed to bearings on each end of an axle at each said eccentric weight and gear set.

10. A vibratory hammer in accordance with claim 9 wherein each said oil collecting well further comprises a front side wall that is perpendicular to and recessed into said interior surface of said head plate and a rear side wall that is perpendicular to and recessed into said interior surface of said head plate with said front and rear side walls being connected to said inwardly sloped side walls and a vertical bore in a center of said oil collecting well terminating upon intersection with one said throughbore.

11. A vibratory hammer comprising:
a. a. an enclosed gear case;
b. at least one rotating eccentric weight and gear set mounted inside said gear case;
c. a head plate on the top of the gear case;
d. at least one oil collecting well formed in an interior surface of said head plate;
e. means for conveying oil collected in said at least on oil collecting well to a bearing at at least one an end of an axle carrying said at least one rotating eccentric weight; and
f. means for rotating said at least one eccentric weight, said rotating means operatively connected to said eccentric weight.

12. A vibratory hammer in accordance with claim 11 further comprising a throughbore through said head plate perpendicular to the length of said head plate in fluid communication with said at least one oil collecting well and means for conveying the collected oil from said bore to bearings inside said enclosed gear case to a bearing at a front of said gear case and to a bearing at a rear of said gear case.

13. A vibratory hammer in accordance with claim 12 wherein said oil collecting well further comprises a recess formed into said interior surface of said head plate adjacent to and in fluid communication with said throughbore.

14. A vibratory hammer in accordance with claim 12 wherein said oil collecting well further comprises a recess having inwardly sloped side walls acting as a funnel to concentrate the location of the collected oil and a front side wall that is perpendicular to and recessed into said interior surface of said head plate and a rear side wall that is perpendicular to and recessed into said interior surface of said head plate with said front and rear side walls being connected to said inwardly sloped side walls and a vertical bore in a center of said oil collecting well terminating upon intersection with one said throughbore.

15. A vibratory hammer in accordance with claim 14 further comprising at least three eccentric weights, each having an attached driving gear, and at least one oil collecting well above each said eccentric weight and gear sets with each said oil collecting well adjacent to and in fluid communication a separate said throughbore, each said throughbore having an end terminating above each end of an axle carrying one said eccentric weight and gear set.

16. A vibratory hammer in accordance with claim 15 wherein each said end of each said throughbore is connected to an oil delivery hose and a distal end of each said oil delivery hose is in fluid communication with the interior of said gear case at a location whereby oil is directed to bearings on each end of an axle at each said eccentric weight and gear set.

17. A vibratory hammer comprising:
a. a. an enclosed gear case;
b. at least one rotating eccentric weight and gear set mounted inside said gear case;
c. a head plate on the top of the gear case;
d. at least one oil collecting well formed in an interior surface of said head plate, said oil collecting well, said oil collecting well further comprising a recess having inwardly sloped side walls acting as a funnel to concentrate the location of the collected oil and a front side wall that is perpendicular to and recessed into said interior surface of said head plate and a rear side wall that is perpendicular to and recessed into said interior surface of said head plate with said front and rear side walls being connected to said inwardly sloped side walls and a vertical bore in a center of said oil collecting well terminating upon intersection with one said throughbore;
e. a throughbore through said head plate from a front edge of said head plate to a rear edge of said head plate, said through bored connected to said vertical center bore, each end of said through bore connected to an oil delivery hose with each said oil delivery hose having a distal end terminating directly over a bearing set; and
f. means for rotating said at least one eccentric weight, said rotating means operatively connected to said eccentric weight.

18. A vibratory hammer in accordance with claim 17 further comprising at least three eccentric weights, each having an attached driving gear, and at least one oil collecting well above each said eccentric weight and gear sets with each said oil collecting well adjacent to and in fluid communication a separate said throughbore, each said throughbore having an end terminating above each end of an axle carrying one said eccentric weight and gear set.

19. A vibratory hammer in accordance with claim 18 wherein each said oil collecting well is formed adjacent to said front edge of said head plate.

20. A vibratory hammer in accordance with claim 17 further comprising a pair of said oil collection wells adjacent to one another and a separate throughbore in fluid communication with one of said oil collection wells with said two throughbore adjacent to one another.
